(19) United States
(12) Patent Application Publication
(10) Pub. No.: US 2015/0269099 A1
(43) Pub. Date: Sep. 24, 2015

(54) STORAGE CONTROLLER, STORAGE APPARATUS, AND COMPUTER READABLE STORAGE MEDIUM HAVING STORAGE CONTROL PROGRAM STORED THEREIN

(71) Applicant: FUJITSU LIMITED, Kawasaki-shi (JP)

(72) Inventors: Hidekazu KAWANO, Saitama (JP); Takashi HIROSE, Adachi (JP); Katsuhiko HADA, Susono (JP); Hironobu SAZUKA, Shizuoka (JP); Toru NAGASAWA, Numazu (JP); Hiroyuki WATANABE, Fuji (JP); Shigeyuki KASHIMA, Koshigaya (JP)

(73) Assignee: Fujitsu Limited, Kawasaki (JP)

(21) Appl. No.: 14/661,519

(22) Filed: Mar. 18, 2015

(30) Foreign Application Priority Data
Mar. 24, 2014 (JP) 2014-060370

(51) Int. Cl. G06F 13/18; G06F 13/40

(52) U.S. Cl. CPC G06F 13/18; G06F 13/4022

(57) ABSTRACT

A storage controller that controls a storage apparatus including a storage area and a plurality of access paths to the storage area is provided, the storage controller including: an obtaining unit that obtains load information indicating loads of the plurality of access paths; a determining unit that determines whether or not access paths to the storage area are to be switched, based on the load information; an identifying unit that identifies a switch candidate access path when it is determined by the determining unit that access paths are to be switched; and a switch instructing unit that instructs to switch to the switch candidate access path identified by the identifying unit.

### CROSS-REFERENCE TO RELATED APPLICATION

This application is based upon and claims the benefit of priority of the prior Japanese Patent application No. 2014-060370, filed on Mar. 24, 2014, the entire contents of which are incorporated herein by reference.

### FIELD

The embodiments discussed herein are related to a storage controller, a storage apparatus, and a non-transitory computer readable storage medium having a storage control program stored therein.

### BACKGROUND

In recent years, storage apparatuses that support the asymmetric logical unit access (ALUA) function have been used (hereinafter, such storage apparatuses are referred to as ALUA-compliant storage apparatuses).

The ALUA functions is specified in the SCSI Primary Commands-3 (SPC-3) standard, for the standard Small Computer Serial Interface (SCSI). The ALUA enables identification of an optimal path between a storage apparatus and a host, and setting of different access levels for respective channel adaptor (CA) ports of a storage apparatus.

Generally speaking, in a storage apparatus, control modules (CMs) are assigned to particular redundant array of independent disks (RAID) groups or logical units (LUNs) configured in the storage apparatus, for performing access controls on those RAID groups or LUNs. Such CMs are referred to as main CMs, while other CMs that do not perform controls are referred to as non-main CMs.

In an ALUA-compliant storage apparatus, an optimum access path to a LUN is the access path via the main CM that is assigned to that LUN. When paths in the storage apparatus are normal, the access path via the main CM is always selected as the optimum path, to which input/output (I/O) operations are executed.

If the load on the main CM is increased, I/Os are queued or the queue overflows in the path via the main CM, resulting in the reduction in the I/O response speed.

In such a situation, even if the access path via the non-main CM can handle I/O operations, that pass is not used for I/O operations, as long as the paths in the storage apparatus do not experience any failure. As a result, a load imbalance between CMs arises, causing an extended response time in the ALUA-compliant storage apparatus.

Accordingly, in an ALUA-compliant storage apparatus, it is desirable to employ paths other than the optimum access path in order to reduce the response time (response time), thereby distributing the loads across the storage apparatus to improve the performance.

### SUMMARY

According to an aspect of the embodiments, a storage controller that controls a storage apparatus including a storage area and a plurality of access paths to the storage area is provided, the storage controller including: an obtaining unit that obtains load information indicating loads of the plurality of access paths; a determining unit that determines whether or not access paths to the storage area are to be switched, based on the load information; an identifying unit that identifies a switch candidate access path when it is determined by the determining unit that access paths are to be switched; and a switch instructing unit that instructs to switch to the switch candidate access path identified by the identifying unit.

Further, a storage apparatus is provided, including: a storage area and a plurality of access paths to the storage area; a storage controller that controls the storage apparatus, the storage controller including: an obtaining unit that obtains load information indicating loads of the plurality of access paths; a determining unit that determines whether or not access paths to the storage area are to be switched, based on the load information; an identifying unit that identifies a switch candidate access path when it is determined by the determining unit that access paths are to be switched; and a switch instructing unit that instructs to switch to the switch candidate access path identified by the identifying unit

Furthermore, a non-transitory computer readable storage medium having a storage control program that controls a storage apparatus including a storage area and a plurality of access paths to the storage area, stored therein is provided, the storage control program, when executed by a computer, causing the computer to: obtain load information indicating loads of the plurality of access paths; determine whether or not access paths to the storage area are to be switched, based on the load information; identify a switch candidate access path when it is determined that access paths are to be switched; and instruct to switch to the identified switch candidate access path.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a system configuration of an information processing system provided with an ALUA-compliant storage apparatus as an example of an embodiment;

FIG. 2 is a diagram illustrating paths in the ALUA-compliant storage apparatus as an example of an embodiment;

FIG. 3 is a diagram illustrating a functional configuration of a path managing unit as an example of an embodiment;

FIG. 4 is a diagram illustrating a CM load table in the storage apparatus as an example of an embodiment;

FIG. 5 is a diagram illustrating a LUN load table in the storage apparatus as an example of an embodiment;

FIG. 6 is a state transition diagram of each LUN in the information processing system as an example of an embodiment;

FIG. 7 is a diagram illustrating the state transition diagram in FIG. 6 for each load of a main CM and a non-main CM, in a tabular form;

FIG. 8 is a flowchart illustrating a path switching in the information processing system as an example of an embodiment;

FIG. 9 is a diagram illustrating a sequence upon a path switching in the information processing system as an example of an embodiment;

FIG. 10 is a diagram illustrating a sequence upon a path switching in the information processing system as an example of an embodiment;

FIG. 11 is a flowchart illustrating a load information obtainment by a load information obtaining unit as an example of an embodiment;

FIG. 12 is a flowchart illustrating storing into a CM load table by the load information obtaining unit illustrated in FIG. 11;

FIG. 13A is a diagram illustrating an example of a LUN load table;

FIG. 13B is a flowchart illustrating storing into a LUN load table by the load information obtaining unit illustrated in FIG. 11;

FIG. 14A is a diagram illustrating an example of a CM load table;

FIG. 14B is a diagram illustrating an example of a LUN load table;

FIG. 15A is a diagram illustrating a path switch candidate area;

FIG. 15B is a diagram illustrating an example of a LUN load table;

FIG. 15C is a flowchart illustrating a switch path extraction by a switch path identifying unit and a path switch instruction by a path switch instructing unit, as an example of an embodiment;

FIG. 16A is a diagram illustrating an example of a LUN load table;

FIG. 16B is a flowchart illustrating a path switch effectiveness confirmation by a path switch effectiveness check unit as an example of an embodiment;

FIG. 17A is a diagram illustrating a CM load table when the path switching is effective;

FIG. 17B is a diagram illustrating a LUN load table when the path switching is effective;

FIG. 18A is a diagram illustrating a CM load table when the path switching is not effective;

FIG. 18B is a diagram illustrating a LUN load table when the path switching is not effective;

FIG. 19 is a flowchart illustrating an all path reset by an all path reset unit as an example of an embodiment;

FIG. 20A is a diagram illustrating a CM load table prior to an all path reset; and

FIG. 20B is a diagram illustrating a LUN load table prior to an all path reset.

### DESCRIPTION OF EMBODIMENT(S)

Hereinafter, a storage controller, a storage apparatus, and a computer readable storage medium having a storage control program stored therein, as an example of the present embodiment, will be described with reference to the drawings.

Note that the embodiments discussed herein are merely exemplary, and it is not intended that various modifications and applications of the teachings not explicitly described are omitted. In other words, the embodiments may be modified, within the scope of the spirit of the embodiments (such as combinations of embodiments and modifications).

### (A) Configuration

Initially, a configuration of an information processing system 1 as an example of an embodiment will be described.

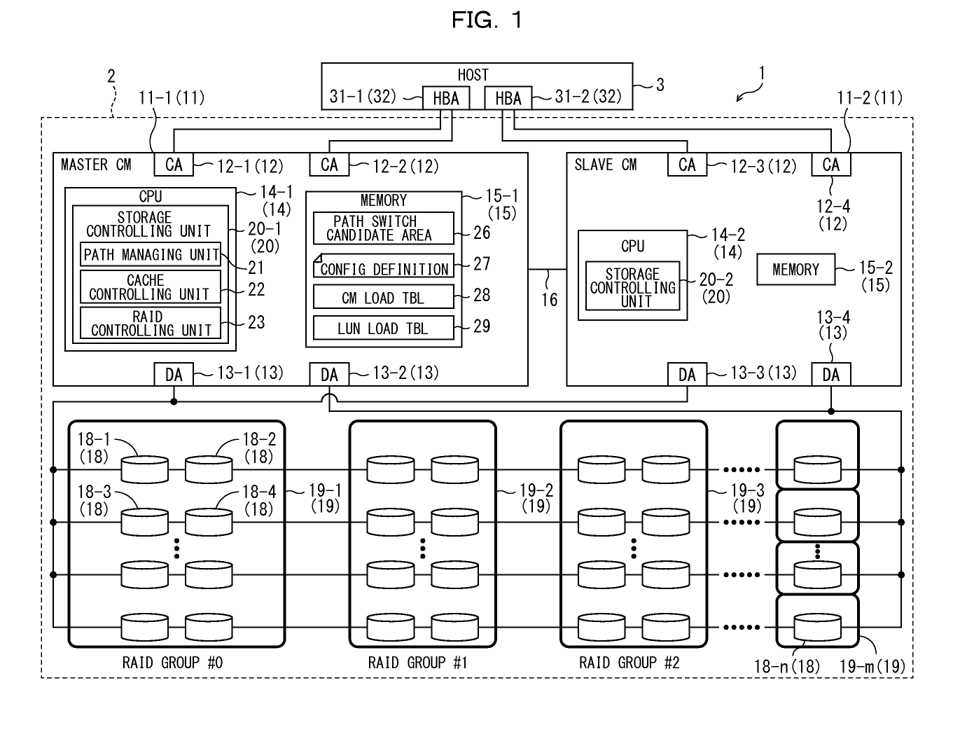

FIG. 1 is a diagram illustrating a system configuration of the information processing system 1 provided with an ALUA-compliant storage apparatus 2 as an example of an embodiment.

The information processing system 1 includes a host 3 and an ALUA-compliant storage apparatus 2, and the host 3 and the ALUA-compliant storage apparatus 2 are connected to each other through a link, such as a local area network (LAN), for example.

The host 3 is an information processing apparatus that executes I/Os, such as reads or writes of data, to the ALUA-compliant storage apparatus 2.

The ALUA-compliant storage apparatus 2 includes multiple (two, in the example illustrated in FIG. 1) CMs 11-1 and 11-2 and disks 18-1 to 18-n (n is an integer of two or greater).

The ALUA-compliant storage apparatus 2 is an ALUA-compliant storage apparatus where the CM 11-1 and the CM 11-2 have different access performances. For the sake of brevity, hereinafter, the ALUA-compliant storage apparatus 2 is also simply referred to as the storage apparatus 2.

The CM 11-1 is a master CM that controls operations of the entire storage apparatus 2. Hence, hereinafter, the CM 11-1 may be also referred to as the master CM 11-1.

The CM 11-2 is a slave CM that is a spare CM for the master CM 11-1. Hence, hereinafter, the CM 11-2 may be also referred to as the slave CM 11-2. Upon a failure of the master CM 11-1, the slave CM 11-2 takes over the functions of the master CM 11-1, and is operated as a new master CM.

Note that, hereinafter, when referring to a specific one of the multiple CMs, reference symbols 11-1 and 11-2 are used, whereas a reference symbol 11 is used when referring to any of the CMs. Hereinafter, the CMs 11-1 and 11-2 may also be referred to as CMs #0 and #1, respectively.

Furthermore, hereinafter, when referring to a specific one of the multiple disks, reference symbols 18-1, 18-2, . . . are used, whereas a reference symbol 18 is used when referring to any of the disks.

The CMs 11-1 and 11-2 are connected to each other through an inter-CM connection 16, such as a Serial Attached SCSI (SAS) or PCI Express® (PCIe) connection. When there are three or more CMs 11, a switch may be provided among the CMs 11.

The disks 18 are hard disk drives (HDDs), for example. In this case, the disks 18 construct multiple RAID groups 19-1 to 19-m (m is an integer of two or greater). Hereinafter, the RAID groups 19-1 to 19-m may also be referred to as RAID groups #0 to #m−1, respectively.

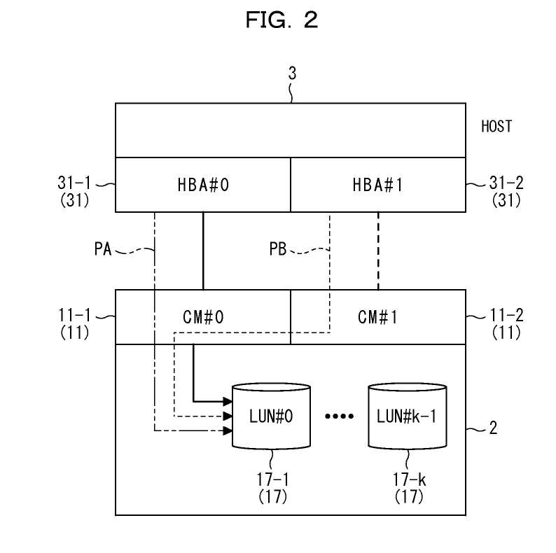

The disks 18 also construct logical units (LUNs, storage areas) 17-0 to 17-k (k is an integer of two or greater) (see FIG. 2), which are logical storage areas to be provided to the host 3, for example.

Note that, hereinafter, when referring to a specific one of LUNs, reference symbols 17-1, 17-2, . . . are used, whereas a reference symbol 17 is used when referring to any of the LUNs.

Furthermore, hereinafter, when referring to a specific one of the multiple RAID groups, reference symbols 19-1 to 19-m are used, whereas a reference symbol 19 is used when referring to any of the RAID groups.

A CM 11 is assigned to each of the LUNs 17-0 to 17-k for managing that LUN 17 (hereinafter, such a CM is referred to as a “main CM” for that LUN). The other CM that is not the main CM for the LUN 17 are referred to as the “non-main CM”.

The associations between the respective disks 18 and the RAID groups 19, and between the respective disks 18 and the LUNs 17 are stored in a configuration definition 27 (described later) in the CMs 11.

The CM 11-1 includes multiple (two, in the example illustrated in FIG. 1) channel adaptors (CAs) 12-1 and 12-2, multiple (two, in the example illustrated in FIG. 1) disk adaptors (DAs) 13-1 and 13-2, a central processing unit (CPU) 14-1, and a memory 15-1.

The CAs 12-1 and 12-2 are modules that connect the host 3 and the CM 11-1. The CAs 12-1 and 12-2 connect the CM 11-1 to the host 3, using a wide variety of communication standards, such as the Fibra Channel (FC), the Internet Small Computer System Interface (iSCSI), the SAS, the Fibre Channel over Ethernet (FCoE), and the Infiniband.

The DAs 13-1 and 13-2 are interfaces, such as expanders and I/O controllers (IOCs), which connect disks 18 (described later) to the CM 11-1, via the SAS for example. The DAs 13-1 and 13-2 control exchanges of data between the CM 11-1 and the disks 18.

The CPU 14-1 is a processing unit that performs a various types of controls and calculations, and embodies various functions by executing the operating system (OS) and programs stored in the memory 15-1 (described later) and the like. The CPU 14-1 also functions as a storage controlling unit 20-1, by executing a storage control program. The CPU 14-1 may be embodied by using any of known CPUs, for example.

The storage controlling unit 20-1 controls the entire operations of the storage apparatus 2, and controls LUNs 17 assigned to the CM 11-1 in which the storage controlling unit 20-1 is provided.

The storage controlling unit 20-1 includes a path managing unit (storage controller) 21, a cache controlling unit 22, and an RAID controlling unit 23.

The path managing unit 21 manages a RAID 19 in the storage apparatus 2 and access paths to the LUN 17. When the load on the main CM 11 is high and the load on the non-main CM 11 low, the path managing unit 21 switches an access path to the LUN 17 (hereinafter, also referred to as paths) to a path via the non-main CM 11 (cross access), thereby distributing the load across the CMs 11. Detailed configuration and functions of the path managing unit 21 will be described later with reference to FIG. 2.

The cache controlling unit 22 performs cache controls between a cache (not illustrated) provided in the CM 11 and the disks 18. The functions of the cache controlling unit 22 are well-known, and any detailed descriptions therefor are omitted.

The RAID controlling unit 23 provides a RAID using the disks 18. The RAID controlling unit 23 controls the configurations of the RAID groups 19-1 to 19-m using the disks 18, based on a configuration definition 27, for example. Here, the configuration definition 27 is data that stores the configuration information of the RAID groups 19-1 to 19-m, volume setting information, and management information for data checks.

The RAID controlling unit 23, when any of the RAID groups 19-1 to 19-m is modified, records the modification in the configuration definition 27. The functions of the RAID controlling unit 23 are well-known, and any detailed descriptions therefor are omitted.

The memory 15-1 stores programs executed by the CPU 14-1, various types of data, and data obtained by operations of the CPU 14-1. The memory 15-1 also functions as a storage unit that stores a configuration definition 27, a CM load table (TBL) 28, a LUN load table 29, and a path switch candidate area 26.

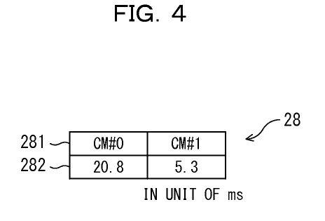

The CM load table 28 stores, as a performance value for each the CMs 11 provided in the storage apparatus 2, the average response time of that CM 11. The detailed configuration of the CM load table 28 will be described later with reference to FIG. 4.

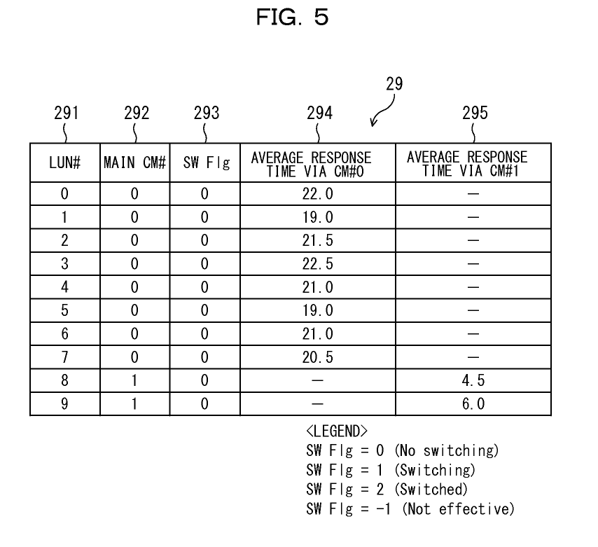

The LUN load table 29 stores, as a performance value for each of the LUNs 17 defined in the storage apparatus 2, the average response time of that LUN 17. The detailed configuration of The LUN load table 29 will be described later with reference to FIG. 5.

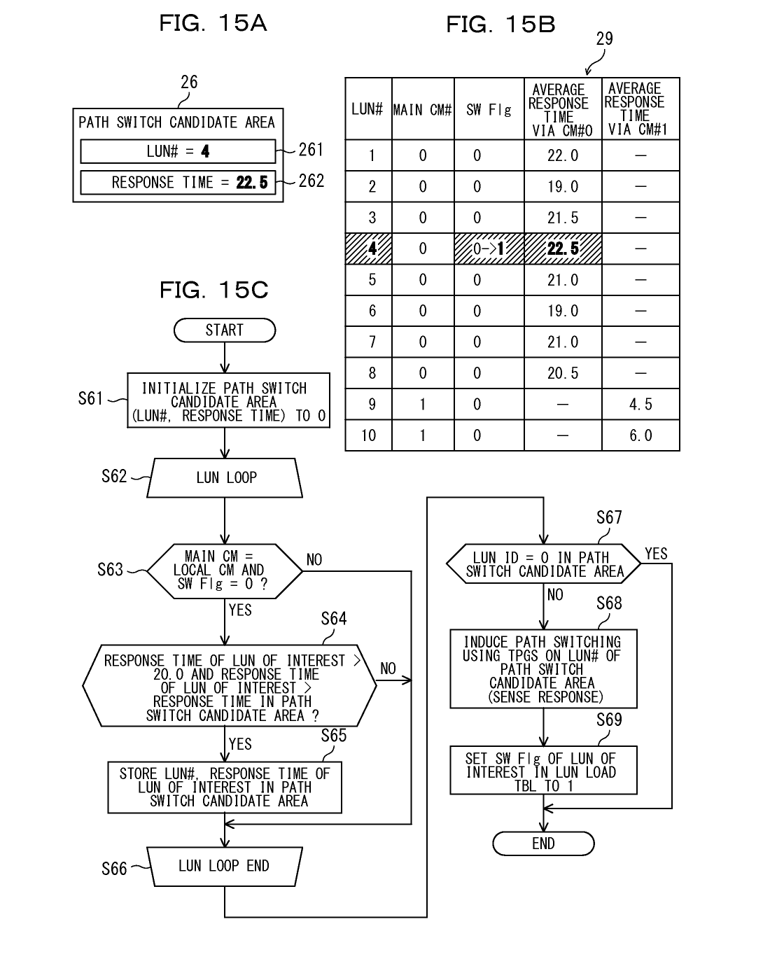

The path switch candidate area 26 is a temporary storage region used by the path managing unit 21, for selecting switch candidate path upon a path switching. As depicted in FIG. 15A, the path switch candidate area 26 includes a LUN #261 that stores an identifier for uniquely identifying each LUN 17 defined in the storage apparatus 2, and a response time 262.

A random access memory (RAM) may be used as the memory 15-1, for example.

Note that components, such as the CAs 12-1 and 12-2, the DAs 13-1 and 13-2, the CPU 14-1, and the memory 15-1, in a CM 11-1 are connected via the PCIe. A switch (not illustrated) may be provided en route.

The CM 11-2 includes multiple (two, in the example illustrated in FIG. 1) CAs 12-3 and 12-4, multiple (two, in the example illustrated in FIG. 1) DAs 13-3 and 13-4, a CPU 14-2, and a memory 15-2.

The CAs 12-3 and 12-4 are modules that connects the host 3 and the CM 11-2. The CAs 12-3 and 12-4 connect the CM 11-2 to the host 3, using a wide variety of communication standards, such as the FC, the iSCSI, the SAS, the FCoE, and the Infiniband.

The DAs 13-3 and 13-4 are interfaces, such as expanders and IOCs, which connect disks 18 (described later) to the CM 11-2, via the SAS for example. The DAs 13-3 and 13-4 control exchanges of data between the CM 11-2 (CM #13-1) and the disks 18.

The CPU 14-2 is a processing unit that performs a various types of controls and calculations, and embodies various functions by executing the OS and programs stored in the memory 15-2 (described later) and the like. The CPU 14-2 also functions as a storage controlling unit 20-2, by executing a storage control program. The CPU 14-2 may be embodied by using any of known CPUs, for example.

The storage controlling unit 20-2 controls the entire operations of the storage apparatus 2, and controls LUNs 17 assigned to the CM 11-2 in which the storage controlling unit 20-2 is provided. The storage controlling unit 20-2 controls the entire operations of the storage apparatus 2, in lieu of the storage controlling unit 20-1, when the master CM 11-1 fails.

The function and configuration of the storage controlling unit 20-2 are similar to the function and configuration of the storage controlling unit 20-1 provided in the CM 11-1, and detailed illustration and description therefor are omitted.

The memory 15-2 stores programs executed by the CPU 14-2, various types of data, and data obtained by operations of the CPU 14-2. The memory 15-2 also functions as a storage unit that stores a configuration definition, a CM load table, a LUN load table, and a path switch candidate area (not illustrated).

The configurations and functions of the configuration definition, the CM load table, the LUN load table, and the path switch candidate area in the memory 15-2 are similar to the configurations and functions of the corresponding components in the CM 11-1, and detailed illustration and description therefor are omitted. The configuration definition of the slave CM 11-2 is obtained by the slave CM 11-2, by making an inquiry to the master CM 11-1.

A RAM may be used as the memory 15-2, for example.

Note that components, such as the CAs 12-3 and 12-4, the DAs 13-3 and 13-4, the CPU 14-2, the memory 15-2, in a CM 11-2 are connected via the PCIe. A switch (not illustrated) may be provided en route.

Note that, hereinafter, when referring to a specific one of CAs, reference symbols 12-1 to 12-4 are used, whereas a reference symbol 12 is used when referring to any of the CAs.

Furthermore, hereinafter, when referring to a specific one of the multiple DAs, reference symbols 13-1 to 13-4 are used, whereas a reference symbol 13 is used when referring to any of the DAs.

Furthermore, hereinafter, when referring to a specific one of the multiple CPUs, reference symbols 14-1 and 14-2 are used, whereas a reference symbol 14 is used when referring to any of the CPUs.

Furthermore, hereinafter, when referring to a specific one of the multiple memories, reference symbols 15-1 and 15-2 are used, whereas a reference symbol 15 is used when referring to any of the memories.

Furthermore, hereinafter, when referring to a specific one of the multiple storage controlling units, reference symbols 20-1 and 20-2 are used, whereas a reference symbol 20 is used when referring to any of the storage controlling units.

FIG. 2 a diagram illustrating paths in the ALUA-compliant storage apparatus 2 as an example of an embodiment.

As set forth above, the storage apparatus 2 is an ALUA-compliant storage apparatus.

The storage apparatus 2 provides the LUNs 17-1 to 17-k (hereinafter, also referred to as the LUNs #0 to #k−1).

The main CM 11 that controls the LUN #0 is the CM 11-1 (also referred to as CM #0), and the CM 11-2 (also referred to as CM #1) is a non-main CM 11 for the LUN #0.

In the ALUA-compliant storage apparatus 2, in an access to the LUN #0, the main CM 11-1 and the non-main CM 11-2 have different I/O access performances, and the path PA through the main CM 11-1 has a higher access performance, and hence has a higher access priority.

In this ALUA-compliant storage apparatus, in a normal operation, the path denoted by reference symbol PA in FIG. 2 is used for an I/O access from the host 3 to the LUN #0 (such a path is referred to as straight access path, and any access through this path is referred to as a straight access). In a conventional ALUA-compliant storage apparatus, even if there is a load imbalance between CMs, the path denoted by reference symbol PB is not used (such a path is referred to as cross access path, and any access through this path is referred to as a cross access), as long as the straight access PA does not fail. The cross access path PB is used only when the straight access path fails or experiences some error.

On the contrary, when a load imbalance arises (i.e., there is a load imbalance) between the CMs 11, the path managing unit 21 (see FIG. 1) as an example of the present embodiment switches the access path to the LUN #0 from the straight access PA to the cross access PB, such that the loads are distributed across the CMs 11.

Hereinafter, changing an access path to a LUN 17 from the straight access PA via the main CM 11 for that LUN 17 to the cross access PB via a non-main CM 11 is referred to as “switching paths” and the action for “switching paths” is referred to as “a path switching”. On the contrary, changing an access path to the LUN 17 from the cross access PB to the straight access PA is referred to as “resetting paths” and the action for “resetting paths” is referred to as “path reset”.

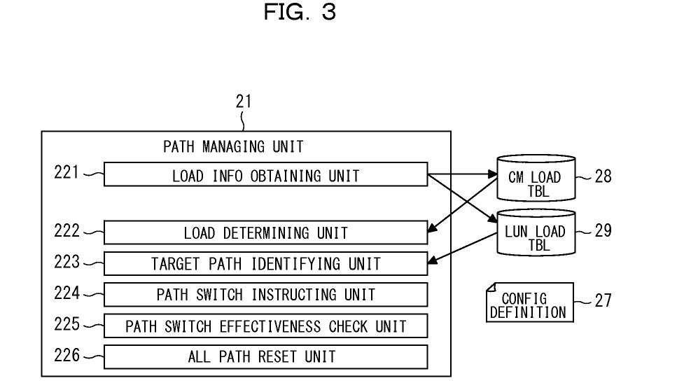

A functional configuration of the path managing unit 21 will be described with reference to FIG. 3.

FIG. 3 is a diagram illustrating a functional configuration of the path managing unit 21 as an example of an embodiment.

The path managing unit 21 includes a load information obtaining unit (obtaining unit) 221, a load determining unit (determining unit) 222, a switch path identifying unit (identifying unit) 223, a path switch instructing unit (switch instructing unit) 224, a path switch effectiveness check unit (checking unit) 225, and an all path reset unit (restoring unit) 226.

The load information obtaining unit 221 obtains load information of the storage apparatus 2, at every certain time interval T1 (e.g., 30 seconds). Specifically, the load information obtaining unit 221 collects the average response time for each of the CMs 11 and each of the LUNs 17. Note that the expression “each response time via CM” means an average response time of LUN for each CM.

The load information obtaining unit 221 collects, for each of the CMs 11, as a command response time, the time duration between when the storage apparatus 2 receives a read/write request from the host 3 and when the storage apparatus 2 handles that request and sends a response for it, at every certain time interval T1. The load information obtaining unit 221 determines, every time when a command response is made, for example, an average of the command response time of the respective CMs 11, and stores the resultant value in a CM average response time 282 in the CM load table 28 (which will be described later with reference to FIG. 4).

At the same time, the load information obtaining unit 221 collects, for each of the LUNs 17, as a command response time, the time duration between when the storage apparatus 2 receives a read/write request from the host 3 and when the storage apparatus 2 handles that request and sends a response for it. The load information obtaining unit 221 determines, every time when a command response is made, for example, an average of the command response time of the respective LUNs 17, and stores the resultant value in average response time 294 and 295 for each CM (every path) in the LUN load table 29 (which will be described later with reference to FIG. 5).

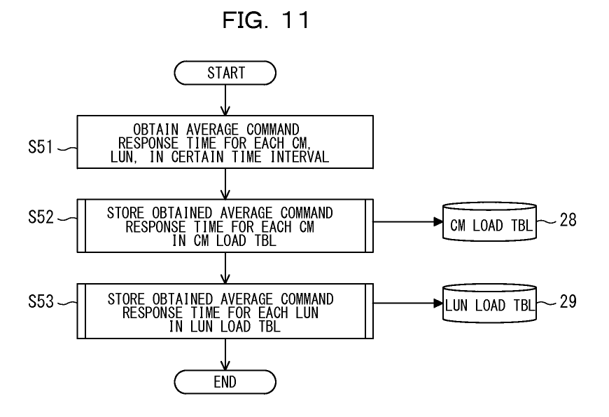

How load information is obtained by the load information obtaining unit 221 will be described later with reference to FIGS. 11 to 13.

The load determining unit 222 determines whether or not a load imbalance arises (i.e., there is a load imbalance) between the CMs 11, based on the load information obtained by the load information obtaining unit 221. Specifically, the load determining unit 222 determines whether or not the load on the main CM 11 is high and the load on the non-main CM 11 is low, using an average response time for each CM 11 in the CM load table 28 collected by the load information obtaining unit 221. For example, when the load on the local CM 11 is high (the CM average response time for the local CM 11 is 20.0 milliseconds (ms) or greater) and the load on another CM 11 is low (the CM average response time for the other CM 11 is less than 10.0 ms), the load determining unit 222 determines that a load imbalance arises between the CMs 11.

The switch path identifying unit 223 selects, if it is determined by the load determining unit 222 that a load imbalance arises between the CMs 11, a candidate path for a path switching (candidate switch path). Specifically, the switch path identifying unit 223 selects, among LUNs 17 under the control of a certain CM 11, a LUN 17 that has not been undergone a path switching and has the largest delay, based on the average command response time for each LUN 17 collected by the load information obtaining unit 221. Hereinafter, the LUN 17 having the largest delay among LUNs 17 under the control of a certain CM 11 is referred to as the “slowest LUN 17”.

Specifically, the switch path identifying unit 223 looks up the LUN load table 29, and identifies the LUN 17 that has the longest average response time, among LUNs 17 which are under the control of the local CM 11 and have not undergone a path switching and have longer average response time. As used herein, the local CM 11 means the CM 11 where the switch path identifying unit 223 is located.

The switch path identifying unit 223 makes determination as of whether the average response time is long, by determining whether or not the average response time is equal to or greater than a predetermined upper-limit threshold TA (e.g., 20.0 ms). Note that the switch path extraction by the switch path identifying unit 223 will be described later with reference to FIGS. 15A-15C.

The path switch instructing unit 224 performs a path switching on the slowest LUN 17 selected by the switch path identifying unit 223, using the Target-Port-Group-Support (TPGS), for changing the access path to the LUN 17 from the straight access PA to the cross access PB.

At this time, the path switch instructing unit 224 waits until the host 3 issues an I/O command to the slowest LUN 17 identified by the switch path identifying unit 223. In response to the I/O command being issued from the host 3 to that LUN 17, the path switch instructing unit 224 makes a sense response for that command utilizing the TPGS, in order to prompt the host 3 to switch the paths. Here, a “sense response” is a response accompanied by an error/information for the SCSI command from the host 3.

The storage apparatus 2 cannot switch paths spontaneously, and can switch paths only when it is instructed by the host 3 to do so. Hence, in response to an I/O command being issued from the host 3 to the slowest LUN 17, the path switch instructing unit 224 makes a sense response to the host 3 utilizing the TPGS, for being instructed by the host 3 for switching paths.

In response to receiving the sense response from the path switch instructing unit 224, the host 3 sends a path confirmation command to the storage apparatus 2, for example, for instructing a path switching to the storage apparatus 2. Note that the TPGS, sense responses, and path confirmation commands are well-known in the art, and descriptions thereof are omitted.

The path switch effectiveness check unit 225 determines whether or not the path switching is effective, after a predetermined time duration T1 after the path switching was performed. Specifically, the path switch effectiveness check unit 225 compares the post-path-switch average response time Ra and the pre-path-switch average response time Rb, for the LUN 17 for which the access paths have been switched.

If the post-path-switch average response time Ra is smaller than the pre-path-switch average response time Rb (Ra<Rb), the path switch effectiveness check unit 225 determines that the path switching is effective, and accepts the path switch (continues to use the switched path).

Otherwise, if the post-path-switch average response time Ra is equal to or greater than the pre-path-switch average response time Rb (Ra≧Rb), the path switch effectiveness check unit 225 determines that the path switching is not effective, and switches the switched path for the LUN 17 back to the previous path.

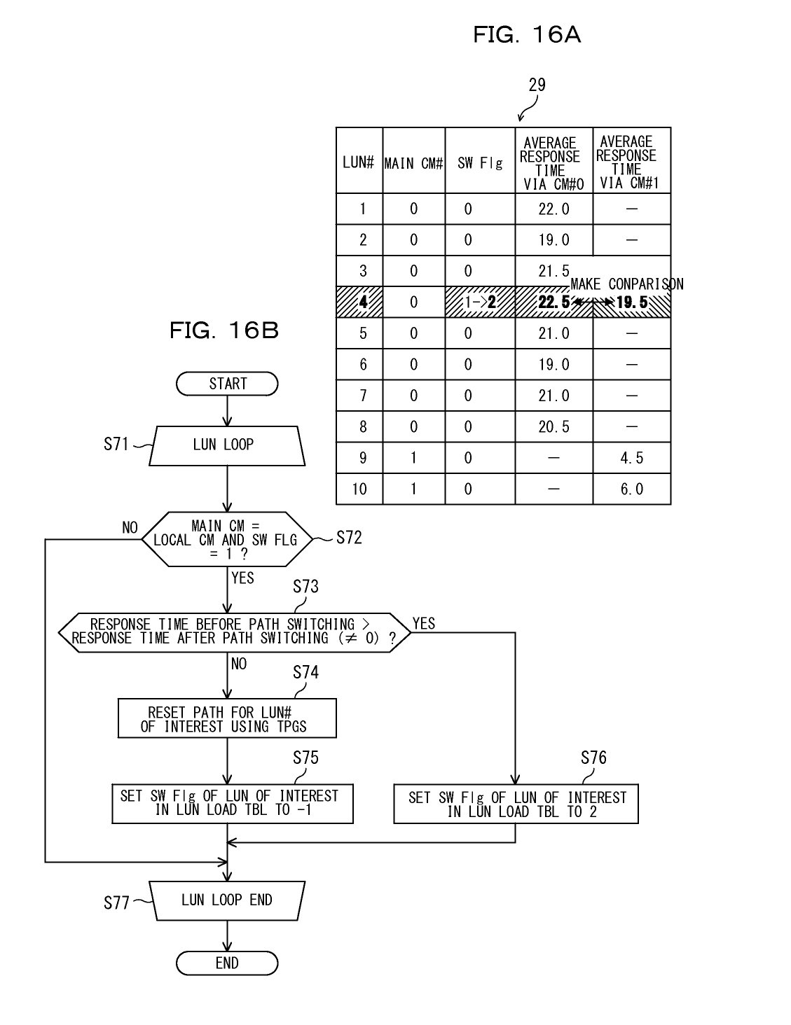

Even when no I/O access is issued from the host 3 after the path switching and accordingly the average response time is 0, the path switch effectiveness check unit 225 determines that the path switching is not effective and resets the paths. The path switch effectiveness confirmation by the path switch effectiveness check unit 225 will be described later with reference to FIG. 16.

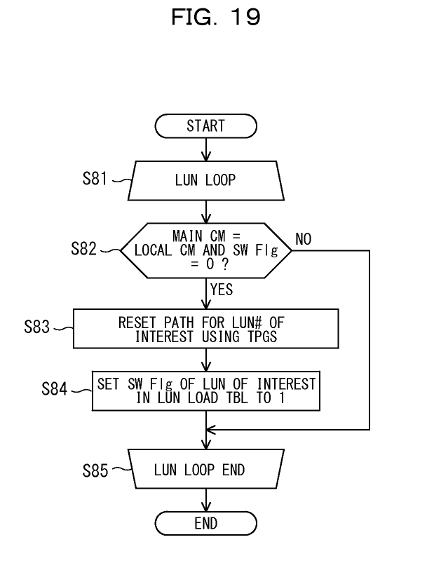

The all path reset unit 226 resets all access paths in the storage apparatus 2 to the respective straight accesses PA via the main CMs 11 for the LUNs 17 (see FIG. 2). The all path reset by the all path reset unit 226 will be described later with reference to FIG. 19.

FIG. 4 is a diagram illustrating the CM load table 28 in the storage apparatus 2 as an example of an embodiment.

The CM load table 28 includes a CM #281 and a CM average response time 282.

The CM #281 is a region that stores a CM ID for uniquely identifying each CM 11 provided in the storage apparatus 2. In the example in FIG. 4, there are two entries of the CM #281 for two CMs 11.

The CM average response time 282 is a region that stores an average response time in the unit of milliseconds (ms), for example, which is obtained by the load information obtaining unit 221 for each CM 11.

FIG. 5 is a diagram illustrating the LUN load table 29 in the storage apparatus 2 as an example of an embodiment.

The LUN load table 29 includes a LUN #291, a main CM #292, a switch flag (FIG. 293, average response time 294 and 295 for each CM route (every path).

The LUN #291 is a region that stores a LUN ID for uniquely identify each LUN 17 defined in the storage apparatus 2.

The main CM #292 is a region that stores an ID for the main CM 11 for the LUN 17 having the LUN ID indicated in the LUN #291. In the example in the first raw in the table in FIG. 5, the value of the main CM #292 for the LUN 17 with the LUN ID=1 is “0”, indicating that the CM 11-1 with CM ID=0 (CM #0) is the main CM for the LUN #1.

The switch flag 293 is a region that stores a flag value indicating path switch status of that LUN 17. A value of “0” in the switch flag 293 indicates that the access path to the LUN #1 has not been switched from the straight access PA to the cross access PB (no switching). A value of “1” indicates that the path is being switched to the cross access PB, but whether or not the switching is effective have not been confirmed, meaning that the switching is preliminary, so to speak. A value of “2” indicates the path has been switched to the cross access PB and whether or not the switching is effective have been confirmed, meaning that the switching is finalized. A value of “−1” indicates that the path had been switched to the cross access PB, but was reset to the straight access PA (switching is not effective).

In the example in the first raw in the table in FIG. 5, the value of the switch flag 293 for the LUN 17 with the LUN ID=0 is “0”, indicating that the path has not been switched to the cross access PB.

The average response time 294 and 295 for each CM route (every path) are regions that store the average response time in the each CM route (every path) for the LUN 17 having the LUN ID indicated in the LUN #291, obtained by the load information obtaining unit 221. The LUN load table 29 is configured such that the number of regions (storage areas) matches the number of CMs 11 provided in the storage apparatus 2.

In the example in FIG. 5, the LUN load table 29 includes an average response time via CM #0 294 and an average response time via CM #1 295.

The average response time via CM #0 294 stores an average response time in the unit of milliseconds (ms), for example, when the LUN 17 having the LUN ID indicated in the LUN #291 is accessed via the CM #0 (the CMs 11-1). In the example in the first raw in the table in FIG. 5, it is indicated that the average response time to the LUN 17 with LUN ID=0 (the LUNs 17, i.e., the LUN #0) via the CM #0 was 22.0 ms.

The average response time via CM #1 295 stores an average access time in the unit of milliseconds (ms), for example, when the LUN 17 having the LUN ID indicated in the LUN #291 is accessed via the CM #1 (the CMs 11-2). In the example in the first raw in the table in FIG. 5, the average response time remains is left blank since the LUN 17 with LUN ID=0 has not been accessed via the CM #1.

Every time any of the CMs 11 is modified, the value of the switch flag 293 in the LUN load table 29 is notified to the path managing unit 21 in the other CM 11 through the inter-CM connection 16. Accordingly, information on a path switching is shared among the CMs 11.

Here, the information on a path switching is shared among the CMs 11, by notifying the other CM 11 of the value of the switch flag 293, by using any well-known inter-CM communication techniques, for example. Specifically, the path managing unit 21 in the CM 11 which is about to change the value of the switch flag 293 notifies the path managing unit 21 in the other CM 11, of the LUN ID to be changed and a new value for the switch flag 293 (0, 1, 2, . . . ) after the modification. In response to receiving this notification, the path managing unit 21 in the other CM 11 update the value in the respective LUN load tables 29.

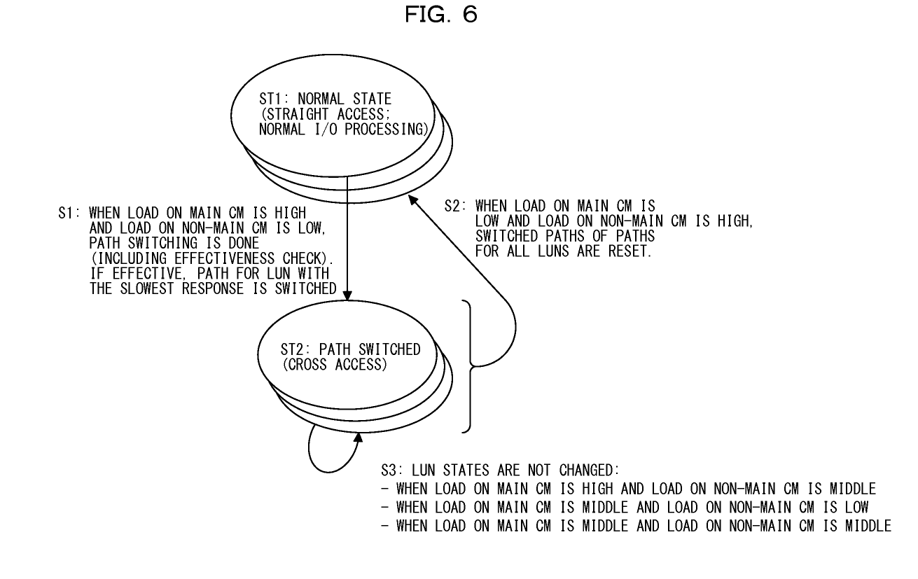

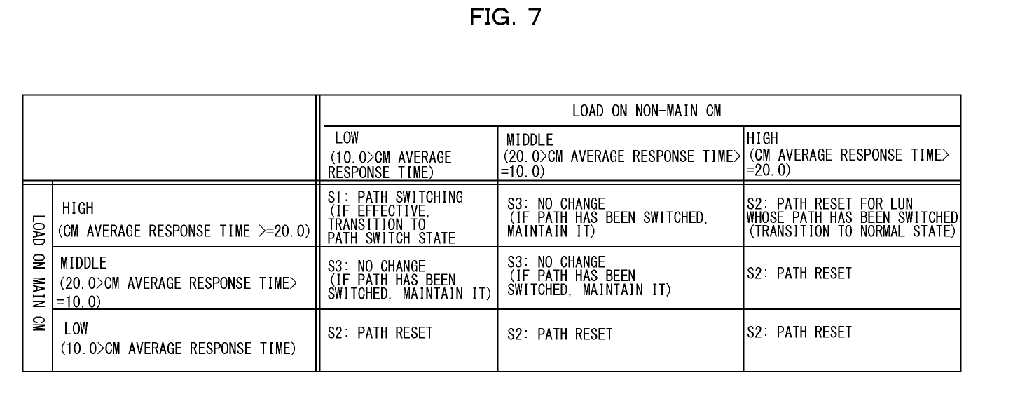

FIG. 6 is a state transition diagram of each LUN in the storage apparatus 2 as an example of an embodiment. FIG. 7 is a diagram illustrating the state transition diagram in FIG. 6 for each load of a main CM 11 and a non-main CM 11, in a tabular form.

The LUNs 17 in the storage apparatus 2 takes two states: The normal state ST1 and the path switched state ST2.

The normal state ST1 is the state where the straight access PA via a main CM 11 (see FIG. 2) is used to access to a LUN 17. The path switched state ST2 is state where a cross access PB via a non-main CM 11 (see FIG. 2) is used to access to the LUN 17.

As depicted in FIGS. 6 and 7, in ST1, the load determining unit 222 determines that the load on the main CM 11 of the LUN 17 becomes high (e.g., the average access time becomes the predetermined upper-limit threshold TA or greater) and the load on the non-main CM 11 is low (e.g., the average access time is smaller than TB).

In this case, in Step S1, the switch path identifying unit 223 selects the slowest LUN 17. The path switch instructing unit 224 then performs a path switching on the slowest LUN 17. Then, after the certain time interval T1, when the path switch effectiveness check unit 225 determines that the path switching is effective, the state transitions to ST2.

In State ST2, when the load determining unit 222 determines that the load on the main CM 11 of the LUN 17 is high and the load on the non-main CM 11 is also medium (e.g., the average access time is the predetermined lower-limit threshold TB=10.0 ms or higher and smaller than TA), no state transition occurs in Step S3 (the current state remains). Or, when it is determined that the load on the main CM 11 is intermediate (e.g., the average access time is no less than TB and less than TA) and the load on the non-main CM 11 is low (e.g., the average access time is smaller than TB), or that the load on the main CM 11 is intermediate (e.g., the average access time is no less than TB and less than TA) and the load on the non-main CM 11 is also intermediate, no state transition occurs.

Otherwise, when in State ST2, the load determining unit 222 determines that the load on the main CM 11 has reduced (e.g., the average access time becomes lower than TB) or, the load on the non-main CM 11 is increased (e.g., the average access time becomes TA or greater), in Step S2, the paths are reset by the path switch instructing unit 224 and the state returns to ST1.

Note that, in an example of the above-described embodiment, a CPU 14 in each CM 11 functions as the path managing unit 21, the load information obtaining unit 221, the load determining unit 222, the switch path identifying unit 223, the path switch instructing unit 224, the path switch effectiveness check unit 225, and the all path reset unit 226 described above, by executing a storage control program.

Note that a program (storage control program) for implementing the functions as the path managing unit 21, the load information obtaining unit 221, the load determining unit 222, the switch path identifying unit 223, the path switch instructing unit 224, the path switch effectiveness check unit 225, and the all path reset unit 226 described above are provided in the form of programs recorded on a computer readable recording medium, such as, for example, a flexible disk, a CD (e.g., CD-ROM, CD-R, CD-RW), a DVD (e.g., DVD-ROM, DVD-RAM, DVD-R, DVD+R, DVD-RW, DVD+RW, HD-DVD), a Blu-ray disc, a magnetic disk, an optical disk, a magneto-optical disk, or the like. The computer then reads a program from that storage medium using a medium reader (not illustrated) and uses that program after transferring it to an internal storage apparatus or external storage apparatus or the like. Alternatively, the program may be recoded on a storage unit (storage medium), for example, a magnetic disk, an optical disk, a magneto-optical disk, or the like, and the program may be provided from the storage unit to the computer through a communication path.

Upon embodying the functions as the path managing unit 21, the load information obtaining unit 221, the load determining unit 222, the switch path identifying unit 223, the path switch instructing unit 224, the path switch effectiveness check unit 225, and the all path reset unit 226 described above, the program (storage management program) stored in an internal storage apparatuses (a memory 15 or a ROM (not illustrated) in a CM 11, in the present embodiment) is executed by a microprocessor of the computer (a CPU 14 in the CM 11, in the present embodiment). In this case, the computer may alternatively read a program stored in a storage medium for executing it.

### (B) Operations

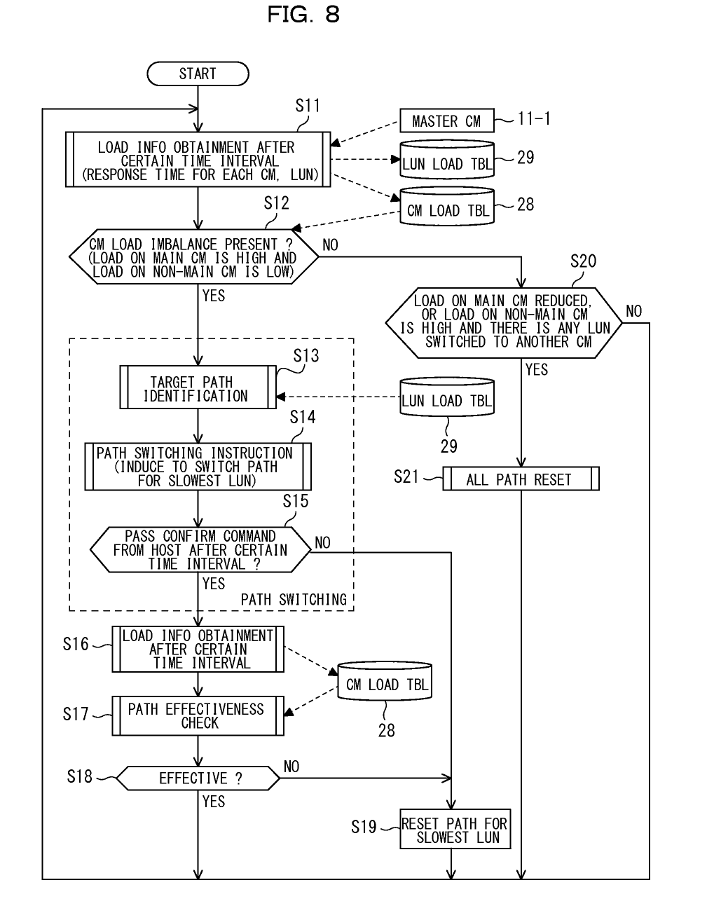

Next, the operations of the storage apparatus 2 as one example of an embodiment will be described with reference to FIGS. 8 to 20.

FIG. 8 is a flowchart (Steps S11 to S21) illustrating a path switching in the information processing system 1 as an example of an embodiment.

In Step S11, the load information obtaining unit 221 performs a load information obtainment, to collect the average command response time, for each CM 11 (the main CM 11 and the non-main CM 11) and for each LUN 17, at every certain time interval T1 (e.g., 30 seconds). The details of the load information obtainment will be described later with reference to FIGS. 11 to 13.

Next, in Step S12, the load determining unit 222 determines whether or not a load imbalance arises between the CMs 11, using the average response time for each CM 11 collected by the load information obtaining unit 221 in Step S12. Specifically, the load determining unit 222 looks up the CM load table 28, and determines whether or not the load on the main CM 11 is high and the load on the non-main CM 11 is low.

If a load imbalance arises between the CMs 11 (refer to the YES route from Step S12), in Step S13, the switch path identifying unit 223 identifies a path to which the access path is to be switched. For this, the switch path identifying unit 223 looks up the LUN load table 29, and selects the path to the LUN 17 having the longest average response time among LUNs 17 under the control of the main CM 11, as a path to be switched to. The operations in Step S13 will be described later with reference to FIG. 15.

Next, in Step S14, the path switch instructing unit 224 performs a path switch instruction on the slowest LUN 17 identified by the switch path identifying unit 223. Specifically, the path switch instructing unit 224 waits until the host 3 issues an I/O command to the slowest LUN 17 identified by the switch path identifying unit 223. In response to the I/O command being issued from the host 3 to that LUN 17, the path switch instructing unit 224 makes a sense response for that command utilizing the TPGS, in order to prompt the host 3 to switch the paths.

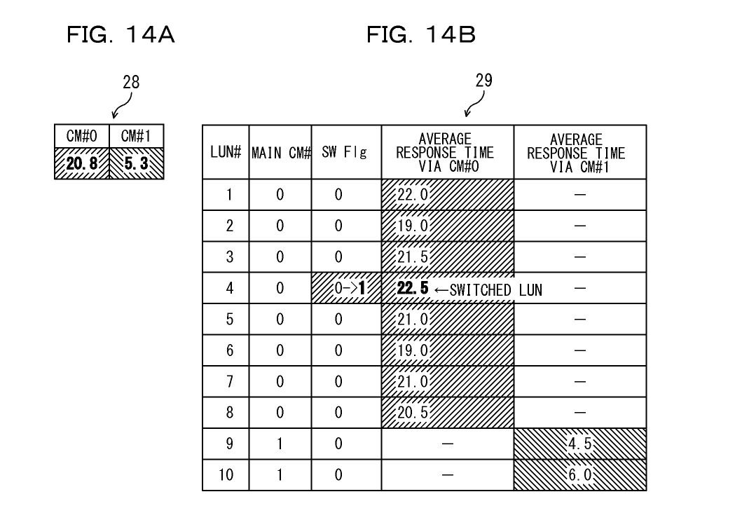

The operations in Steps S13 and S14 described above will be described later with reference to FIGS. 14 and 15.

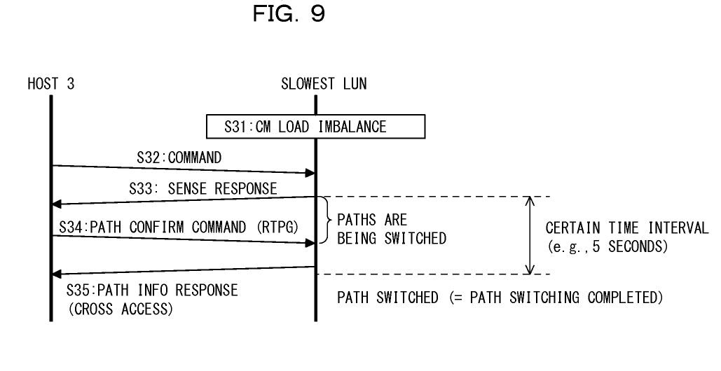

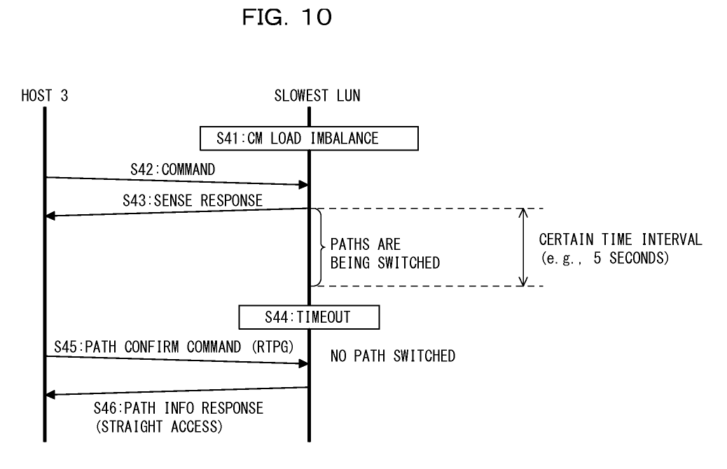

Next, in Step S15, the path switch instructing unit 224 determines whether or not a path confirmation command is received from the host 3 and the path switching is finalized, within a predetermined time duration T2 (e.g., five seconds). Hereinafter, the processing in the above-described Step S13 to S15 is collectively referred to as “path switching”. A command sequence with the host 3 during a path switching will be described later with reference to FIGS. 9 and 10.

If the path switching is not finalized within the predetermined time duration T2 (refer to the NO route from Step S15), in Step S19, the path switch instructing unit 224 resets the paths for the slowest LUN 17 to the previous ones (resets the paths). At this time, the path switch instructing unit 224 waits until the host 3 issues an I/O command to the LUN 17 for which the access paths have been switched in Steps S14 and S15. In response to the I/O command being issued from the host 3 to that LUN 17, the path switch instructing unit 224, makes a sense response for this command, by utilizing the TPGS, to prompt the host 3 to reset the paths. The flow then returns to Step S11.

Otherwise, if the path switching is finalized within the predetermined time duration T2 (refer to the YES route from Step S15), in Step S16, the load information obtaining unit 221 obtains load information of the LUN 17 to which the path switching was performed, after a certain time interval T1 (e.g., 30 seconds).

Next, in Step S17, the path switch effectiveness check unit 225 performs a path switch effectiveness confirmation. Specifically, path switch effectiveness check unit 22 compares the post-path-switch average response time Ra (via the non-main CM 11) collected in Step S16, and the pre-path-switch average response time Rb (via the non-main CM 11) collected in Step S11. If the post-path-switch average response time Ra is smaller than the pre-path-switch average response time Rb (Ra<Rb), the path switch effectiveness check unit 22 determines that the path switching is effective. On the contrary, the post-path-switch average response time Ra is equal to or greater than the pre-path-switch average response time Rb (Ra≧Rb), the path switch effectiveness check unit 22 determines that the path switching is not effective. Note that the path switch effectiveness confirmation will be described later with reference to FIG. 16.

In Step S18, the path switch effectiveness check unit 225 determines whether or not the path switching was determined as effective in Step S17.

If the path switching was determined as effective (refer to the YES route from Step S18), and the flow returns to Step S11.

Otherwise, if the path switching was not determined as effective (refer to the NO route from Step S18), in Step S19, the path switch instructing unit 224 resets the paths for the slowest LUN 17 to the previous ones (resets the path). The flow then returns to Step S11.

Otherwise, if no load imbalance arises between the CMs 11 in Step S12 (refer to the NO route from Step S12), in Step S20, the load determining unit 222 determines whether or not there is any LUN 17 where the load on the main CM 11 declines or the load on the non-main CM 11 is increased, and the path has been switched.

If the determination in Step S20 results in TRUE (refer to the YES route from Step S20), in Step S21, all path reset unit 22 performs an all path reset (all path reset will be described later with reference to FIG. 19). Thereafter, the flow returns to Step S11.

Otherwise, if the determination in Step S19 results in FALSE (refer to the NO route from Step S20), and the flow returns to Step S11.

Here, the sequence of the path switching in Steps S14 and S15 in FIG. 8 will be described.

FIG. 9 is a diagram illustrating a sequence (Steps S31 to S35) upon a path switching in the information processing system 1 as an example of an embodiment.

This example indicates a case where a path confirmation command from the host 3 arrives at the storage apparatus 2 within a predetermined time duration T2 (e.g., five seconds), after a sense response by the path switch instructing unit 224 in Step S14 in FIG. 8.

In Step S31, when the load determining unit 222 detects that there is a load imbalance among the CMs 11 and determines that a path switching is required, the switch path identifying unit 223 identifies the slowest LUN 17. The path switch instructing unit 224 then waits for a host I/O to the slowest LUN 17 identified by the switch path identifying unit 223.

Thereafter, in Step S32, the host 3 issues a command to the slowest LUN 17 identified by the path switch instructing unit 224 in Step S31.

In Step S33, for the I/O command received from the host 3 in Step S32, the path switch instructing unit 224 performs a sense response to the host 3 on the slowest LUN 17.

In Step S34, after the sense response in Step S33, a path confirmation command from the host 3 arrives at the storage apparatus 2 (specifically, the slowest LUN 17), within a predetermined time duration T2 (e.g., five seconds).

In this case, in Step S35, the path switch instructing unit 224 sends the host 3, a path information response notifying that the path has been switched to the cross access PB via a non-main CM 11. Thereby, any accesses to the slowest LUN 17 identified in Step S31 are made through the cross access PB.

FIG. 10 is a diagram illustrating a sequence (Steps S41 to S46) upon a path switching in the information processing system 1 as an example of an embodiment.

This example indicates a case where no path confirmation command from the host 3 arrives at the storage apparatus 2 (or an arrival of the command is delayed), within a predetermined time duration T2 (e.g., five seconds), after a sense response by the path switch instructing unit 224 in Step S14 in FIG. 8.

In Step S41, when the load determining unit 222 detects that there is a load imbalance among the CMs 11 and determines that a path switching is required, the switch path identifying unit 223 identifies the slowest LUN 17. The path switch instructing unit 224 then waits for a host I/O to the slowest LUN 17 identified by the switch path identifying unit 223.

Thereafter, in Step S42, the host 3 issues a command to the slowest LUN 17 identified by the path switch instructing unit 224 in Step S41.

In Step S43, for the I/O command received from the host 3 in Step S42, the path switch instructing unit 224 performs a sense response to the host 3 on the slowest LUN 17.

In Step S44, after the sense response in Step S43, a predetermined time duration T2 (e.g., five seconds) elapses and a reception of a path confirmation command from the host 3 is timed out.

Thereafter, in Step S45, a path confirmation command from the host 3 arrives at the storage apparatus 2 (specifically, the slowest LUN 17).

In this case, in Step S46, the path switch instructing unit 224, the path switch instructing unit 224 sends the host 3, a path information response notifying that the path has not switched from the straight access PA via the main CM 11. Thereby, any accesses to the slowest LUN 17 identified in Step S41 are made through the straight access PA as before.

Next, a load information obtainment by the load information obtaining unit 221 in Step S11 in FIG. 8 will be described with reference to FIGS. 11 to 13.

FIG. 11 is a flowchart (Steps S51 to S53) illustrating a load information obtainment by the load information obtaining unit 221 as an example of an embodiment.

In Step S51, the load information obtaining unit 221 obtains the average command response time for each CM 11 and for each LUN 17, at every certain time interval T1 (e.g., 30 seconds).

Specifically, the load information obtaining unit 221 collects, for each of the CMs 11, as a command response time, the time duration between when the storage apparatus 2 receives a read/write request from the host 3 and when the storage apparatus 2 handles that request and sends a response for it, at every certain time interval T1. The load information obtaining unit 221 determines, every time when a command response is made, for example, an average of the command response time of the respective CMs 11.

Furthermore, the load information obtaining unit 221 collects, for each of the LUNs 17, as a command response time, the time duration between when the storage apparatus 2 receives a read/write request from the host 3 and when the storage apparatus 2 handles that request and sends a response for it. The load information obtaining unit 221 determines, every time when a command response is made, for example, an average of the command response time of the respective LUNs 17.

Next, in Step S52, the load information obtaining unit 221 stores the average command response time for each CM obtained in Step S51, into the CM load table 28.

In Step S53, the load information obtaining unit 221 stores the average command response time for each LUN 17 obtained in Step S51, into the LUN load table 29.

Note that the above-described Steps S52 and S53 may be performed simultaneously, or performed in the revered order.

Next, storing into the CM load table 28 in Step S52 in FIG. 11 will be described in detail.

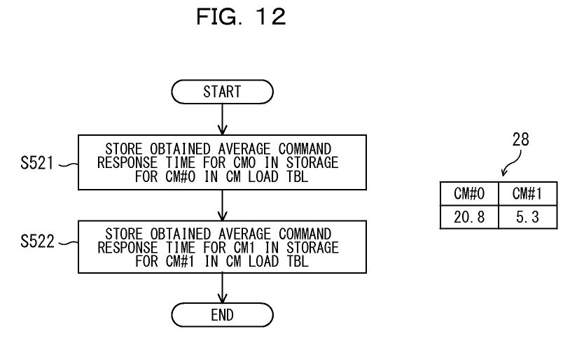

FIG. 12 is a flowchart (Steps S521 to S522) illustrating storing into the CM load table 28 by the load information obtaining unit 221 illustrated in FIG. 11.

In Step S521, the load information obtaining unit 221 stores the average command response time for CM #0 (the CMs 11-1) obtained in Step S51 in FIG. 11, into the CM load table 28.

In Step S522, the load information obtaining unit 221 stores the average command response time for CM #1 (the CMs 11-2) obtained in Step S51 in FIG. 11, into the CM load table 28.

Next, storing into the LUN load table 29 in Step S53 in FIG. 11 will be described in detail.

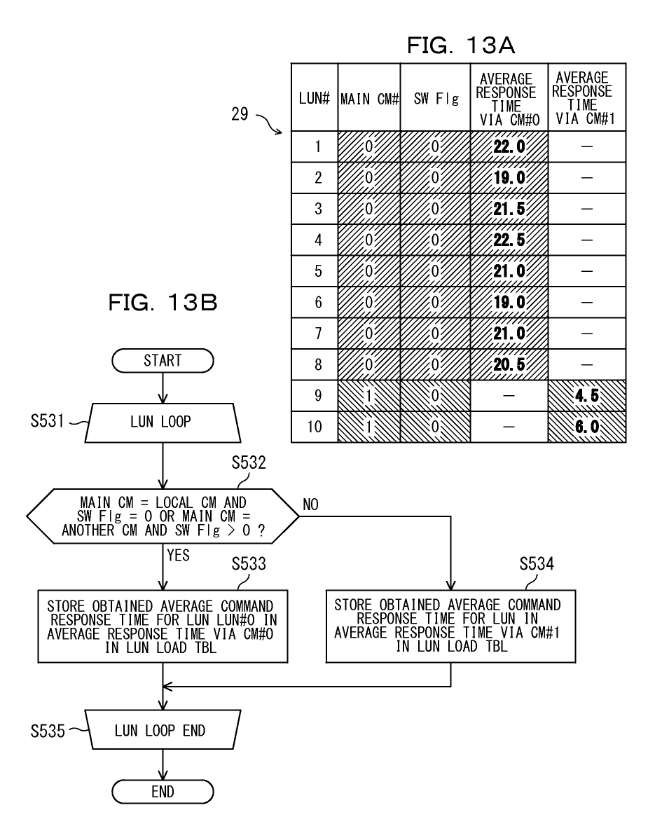

FIG. 13A is a diagram illustrating an example of the LUN load table 29. FIG. 13B is a flowchart (Steps S531 to S535) illustrating storing into the LUN load table 29 by the load information obtaining unit 221 illustrated in FIG. 11. This flow is independently executed on each CM 11.

The LUN load table 29 in FIG. 13A, the modified entries are indicated by the bold-typed face.

In Step S531, the load information obtaining unit 221 moves to the first record in the LUN load table 29.

In Step S532, the load information obtaining unit 221 determines whether or not the main CM 11 in the record selected in Step S531 is the CM 11 (local CM) executing this flow, and the value of the switch flag 293 in the record selected in Step S531 is “0”, or the main CM 11 in the record selected in Step S531 is not the local CM 11 (another CM), and the value of the switch flag 293 in the record selected in Step S531 exceeds “0”.

If the determination in Step S532 results in TRUE (refer to the YES route from Step S532), the load information obtaining unit 221 stores, in Step S533, the average response time for the LUNs 17 obtained in Step S51 in FIG. 11, into the average response time via CM #0 294 in the LUN load table 29.

Otherwise, if the determination in Step S532 results in FALSE (refer to the NO route from Step S532), the load information obtaining unit 221 stores, in Step S534, the average response time for the LUNs 17 obtained in Step S51 in FIG. 11, into the average response time via CM #1 295 in the LUN load table 29.

Next, in Step S535, the load information obtaining unit 221 moves to the next record in the LUN load table 29, and repeats the above-described Steps S532 to S534. The load information obtaining unit 221 repeats the above-described Step S532 to S534, until processing of the last record in the LUN load table 29 is completed.

Next, the switch path extraction and instruction in Steps S13 and S14 in FIG. 8 will be described with reference to FIGS. 14A and 14B, and FIGS. 15A-15C.

FIG. 14A is a diagram illustrating an example of the CM load table 28, and FIG. 14B is a diagram illustrating an example of the LUN load table 29. FIG. 15A is a diagram illustrating the path switch candidate area 26, and FIG. 15B is a diagram illustrating an example of the LUN load table 29. FIG. 15C is a flowchart (Steps S61 to S69) illustrating a switch path extraction by the switch path identifying unit 223 and a path switch instruction by the path switch instructing unit 224, as an example of an embodiment.

An example of an imbalance of a CM load in the storage apparatus 2 is illustrated in FIG. 14A. In the example in FIG. 14A, for example, the average response time of the CM 11-1 is the predetermined upper-limit threshold TA (e.g., 20 ms) or higher, while the average response time of the CM 11-2 remains low.

In such a case, as described above, in Step S14 in FIG. 8, the switch determining unit 222 determines that a path switching is required. The switch path identifying unit 223 then performs a switch path extraction (Steps S61 to S66) to identify a cross access PB for switching the path. This flow is independently executed on each CM 11.

Specifically, the switch path identifying unit 223 initializes, in Step S61 in FIG. 15B, the LUN #261 and the response time 262 in the path switch candidate area 26 (refer to FIG. 1) located in the memory 15 in the CM 11, to a value of “0”.

Next, in Step S62, the switch path identifying unit 223 moves to the first record in the LUN load table 29.

In Step S63, the switch path identifying unit 223 determines whether or not the main CM 11 in the record selected in Step S62 is the CM 11 (local CM) executing this flow and the value of the switch flag 293 in that record is “0” (no switching).

If the determination in Step S63 results in FALSE (refer to the NO route from Step S63), the switch path identifying unit 223 moves to the next record in the LUN load table 29 Step S63 returns to.

Otherwise, if the determination in Step S63 results in TRUE (refer to the YES route from Step S63), in Step S64, the switch path identifying unit 223 determines whether or not the average response time for the LUN 17 of the record selected in Step S62 exceeds the predetermined upper-limit threshold TA, and that average response time for the LUN 17 exceeds the value stored in a storage area in the response time 262 in the path switch candidate area 26.

If the determination In Step S64 results in FALSE (refer to the NO route from Step S64), the switch path identifying unit 223 moves to the next record in the LUN load table 29 Step S63 returns to.

Otherwise, if the determination in Step S64 results in TRUE (refer to the YES route from Step S64), in Step S65, the switch path identifying unit 223 stores the LUN # and the average response time of the LUN 17 of the record selected in Step S62, into the LUN #261 and the response time 262 in the path switch candidate area 26, respectively. Thereafter, the switch path identifying unit 223 moves to the next record in the LUN load table 29 and returns to Step S63, thereby repeating the above-described Steps S63 to S65. The switch path identifying unit 223 repeats the above-described Steps S62 to S65, until processing of the last record in the LUN load table 29 is completed.

In the above-described Steps S62 to S66, as illustrated in the example of the LUN load table 29 in FIG. 15A, the switch path identifying unit 223 selects the LUN #4 having the highest average response time of 22.5 ms as the slowest LUN 17, and records values of “4” and “22.5” into the LUN #261 and the response time 262 in the path switch candidate area 26, respectively.

Next, the path switch instructing unit 224 performs a path switching (Steps S67 to S69).

In Step S67, the path switch instructing unit 224 determines whether or not the LUN #261 in the path switch candidate area 26 is “0”.

If the LUN #261 in the path switch candidate area 26 is “0” (refer to the YES route from Step S67), no switch candidate path was selected in the switch path extraction and the path switch instructing unit 224 terminates this flow.

Otherwise, if the LUN #261 in the path switch candidate area 26 is not “0” (refer to the NO route from Step S67), a switch candidate path was selected in the switch path extraction. Thus, in Step S68, the path switch instructing unit 224 makes a sense response to the host 3 for the LUN 17 stored in the LUN #261 in the path switch candidate area 26, by utilizing the TPGS, thereby prompting the host 3 to switch paths.

In Step S69, the path switch instructing unit 224 changes the switch flag 293 in the LUN load table 29, for the LUN 17 for which the path switching was prompted to “1” (being switched), and terminates this flow. In the example of the LUN load table 29 in FIG. 15A, the value of switch Flg for the LUN #=4 is changed to “1”.

Next, the path switch effectiveness confirmation in Step S17 in FIG. 8 will be described with reference to FIGS. 16A and 16B to FIGS. 18A and 18B.

FIG. 16A is a diagram illustrating an example of the LUN load table 29, and FIG. 16B is a flowchart (Steps S71 to S77) illustrating a path switch effectiveness confirmation by the path switch effectiveness check unit 225 as an example of an embodiment. This path switch effectiveness confirmation is independently executed in each CM 11.

In Step S71 in FIG. 16B, the path switch effectiveness check unit 225 moves to the first record in the LUN load table 29.

In Step S72, the path switch effectiveness check unit 225 determines whether or not the main CM 11 in the record selected in Step S71 is the CM 11 (local CM) executing this flow and the value of the switch flag 293 in that record is “1” (switched).

If the determination in Step S72 results in FALSE (refer to the NO route from Step S72), the path switch effectiveness check unit 225 moves to the next record in the LUN load table 29 and returns to Step S72.

Otherwise, if the determination in Step S72 results in TRUE (refer to the YES route from Step S72), paths have been switched. Thus, in Step S73, the path switch effectiveness check unit 225 looks up the LUN load table 29, and determines whether or not the pre-path-switch average response time Rb exceeds the response time Ra after the path switching. If so, the path switch effectiveness check unit 225 determines that the path switching is effective. Otherwise, if the pre-path-switch average response time Rb is equal to or less than the response time Ra after the path switching, the path switch effectiveness check unit 225 determines that the path switching is not effective.

For example, in the example in the LUN load table 29 in FIG. 16A, since the pre-path-switch average response time Rb=22.5 for the LUN #4 exceeds the response time Ra after the path switching=19.5, the path switch effectiveness check unit 225 determines that the path switching is effective.

If the path switching was determined as effective (refer to the YES route from Step S73), in Step S76, the path switch effectiveness check unit 225 sets “2” (switched) to the switch flag 293 in the LUN load table 29 for that LUN 17 to finalize the path switching, and moves to Step S77 (described late).

Otherwise, if the path switching was not determined as effective (refer to the NO route from Step S73), in Step S74, using the TPGS, the LUN 17 of the interest resets the path.

Then, in Step S75, the path switch effectiveness check unit 225 sets “−1” (switching is not effective) to the switch flag 293 in the LUN load table 29 for that LUN 17.

Thereafter, the path switch effectiveness check unit 225 moves to the next record in the LUN load table 29 Step S77, and repeats the above-described Step S73 to S76. The path switch effectiveness check unit 225 repeats the above-described Steps S73 to S76 until processing of the last record in the LUN load table 29 is completed.

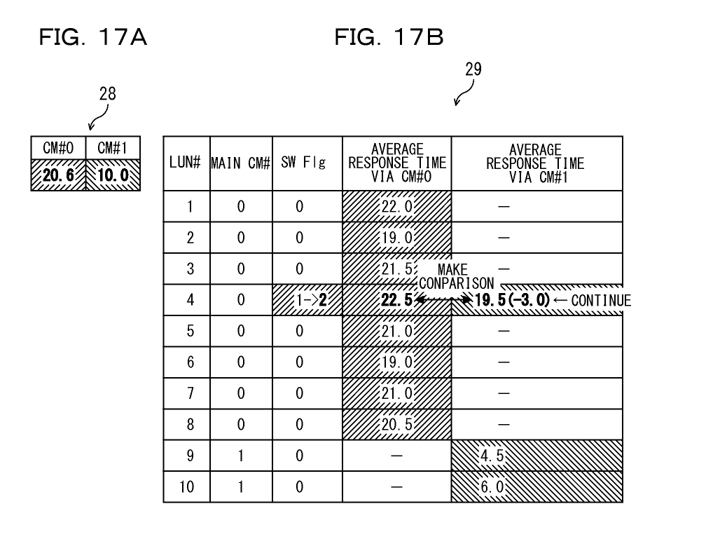

FIGS. 17A and 17B are diagrams illustrating an example when the path switching is effective. FIG. 17A is a diagram illustrating an example of the CM load table 28, and FIG. 17B is a diagram illustrating the LUN load table 29.

In the example in this diagram, since the pre-path-switch average response time Rb=22.5 exceeds the response time Ra after the path switching=19.5, the path switch effectiveness check unit 225 determines that the path switching is effective. Thus, the path switch effectiveness check unit 225 sets “2” to the switch flag 293 in the LUN load table 29 for that LUN 17, to finalize the path switching.

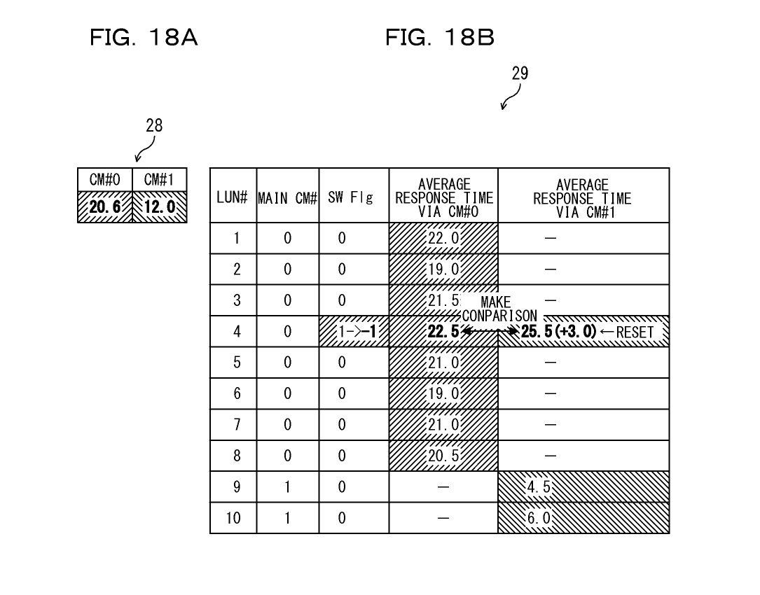

FIGS. 18A and 18B are diagrams illustrating an example when the path switching is not effective. FIG. 18A is a diagram illustrating an example of the CM load table 28, and FIG. 18B is a diagram illustrating the LUN load table 29.

In the example in this diagram, since the pre-path-switch average response time Rb=22.5 is equal to or smaller than the response time Ra after the path switching=25.5, the path switch effectiveness check unit 225 determines that the path switching is not effective. Thus, the path switch effectiveness check unit 225 sets “−1” to the switch flag 293 in the LUN load table 29 for that LUN 17 to reset the paths.

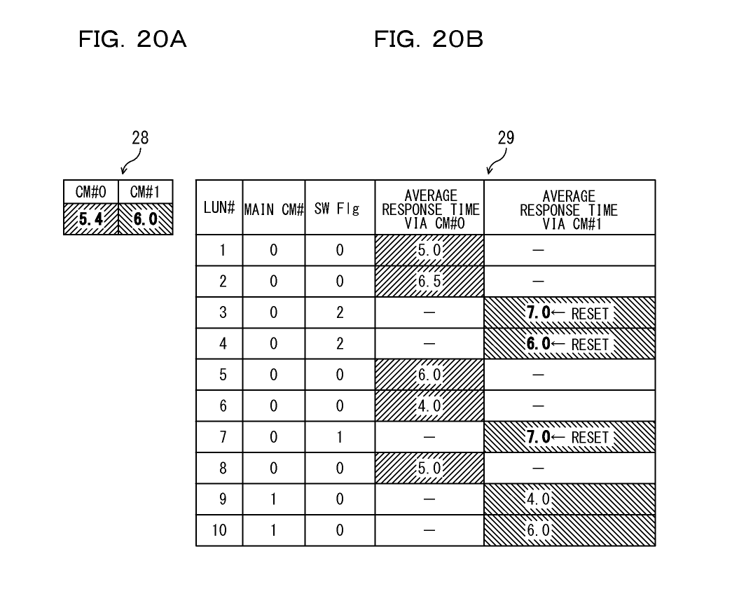

Next, the all path reset in Step S17 in FIG. 8 will be described with reference to FIGS. 19, 20A, and 20B.

FIG. 19 is a flowchart (Steps S81 to S85) illustrating an all path reset by the all path reset unit 226 as an example of an embodiment. This flow is independently executed on each CM 11.

In Step S81, the all path reset unit 226 moves to the first record in the LUN load table 29.

In Step S82, the all path reset unit 226 determines whether or not the main CM 11 in the record selected in Step S81 is the CM 11 (local CM) executing this flow and the value of the switch flag 293 for the record selected in Step S81 exceeds “0”.

If the determination in Step S82 results in FALSE (refer to the NO route from Step S82), the all path reset unit 226 moves to the next record in the LUN load table 29 Step S82 returns to.

Otherwise, if the determination in Step S82 results in TRUE (refer to the YES route from Step S82), in Step S83, the all path reset unit 226 prompts the host 3 to resets the paths, by utilizing the TPGS, for the LUN 17 of the LUN# the record selected in Step S81 in the LUN load table 29. Specifically, the all path reset unit 226 waits until an I/O command to that LUN 17 is issued from the host 3. When an I/O command to that LUN 17 is issued from the host 3, the all path reset unit 226 makes a sense response for this command utilizing the TPGS, to prompt the host 3 to resets the paths.

In Step S84, the all path reset unit 226 sets the switch flag 293 in the LUN load table 29 for that LUN 17 to “0”.

Thereafter, the all path reset unit 226 moves to the next record in the LUN load table 29 and returns to Step S82, and the above-described Steps S83 to S85 are repeated. The all path reset unit 226 repeats the above-described Steps S83 to S85, until processing of the last record in the LUN load table 29 is completed.

FIGS. 20A and B are diagrams illustrating tables prior to an all path reset. FIG. 20A is a diagram illustrating an example of the CM load table 28, and FIG. 20B is a diagram illustrating the LUN load table 29.

In this example, paths for LUN 17 having the switch flag 293 in the LUN load table 29 of “1” or “2” have been switched. The all path reset unit 226 resets all of these paths.

### (C) Advantageous Effects

As set forth above, in accordance with an example of an embodiment, the load information obtaining unit 221 in the path managing unit 21 monitors the respective average response time for the LUNs 17, as loads for each CM 11 and for each LUN 17. The load determining unit 222 then determines whether or not there is any load imbalance among the CMs 11, and if there is a load imbalance (i.e., a load imbalance arises) between the CMs 11, it is determined that a path switching is required.

Next, the switch path identifying unit 223 identifies the slowest LUN 17, and the path switch instructing unit 224 switches the paths for the slowest LUN 17 that is identified by the switch path identifying unit 223.

As a result, loads are distributed across the CMs 11 in the ALUA-compliant storage apparatus 2. Since the situation where the I/O loads are concentrated on a particular CM 11, the response time in the entire storage apparatus 2 can be reduced.

After a path switching, if the load determining unit 222 detects that the load imbalance among the CMs 11 was eliminated, in other words, the load the main CM 11 for which path was switched has been reduced or the load on the non-main CM 11 has increased, the path switch instructing unit 224 resets the paths for that LUN 17.

Since a path that provides a shorter response time is always selected in the ALUA-compliant storage apparatus 2 configured as described above, loads are distributed among the CMs 11, I/O responses of the storage apparatus 2 are improved, thereby reducing the response time.

As set forth above, in this storage apparatus 2, when the load on the main CM 11 is high and a delay of processing arises, the access path of a non-main CM 11 that has a remaining processing capability can be utilized to resolve the response delay.

### (D) Miscellaneous

Note that the present disclosure is not limited to the embodiments described above, and various modifications may be made without departing from the spirit of the present disclosure.

For example, although each CM 11 includes two CAs 12 and two DAs 13 in an example of the above-described embodiment, each CM 11 may include one or three or more CAs 12 and DAs 13.

Furthermore, although each CM 11 includes one CPU 14 and one memory 15 in an example of the above-described embodiment, each CM 11 may include multiple CPUs 14 and memories 15.

Furthermore, although the disks 18 are HDDs in an example of the above-described embodiment, the disks 18 may be other types of storage apparatuses, such as solid state disks (SSDs).

Furthermore, although the storage apparatus 2 has a RAID configuration where multiple disks 18 configure a RAID group 19, the storage apparatus 2 may not have a RAID configuration.

Furthermore, although the load information obtaining unit 221 collects the average response time as load information in an example of the above-described embodiment, the load information obtaining unit 221 may collect, as the load information, other information, such as the number of processes or the number of queue processes.

Furthermore, although the certain time interval T1, the predetermined time duration T2, the upper-limit threshold TA, the lower-limit threshold TB are described as 30 seconds, five seconds, 20.0 ms, and 10.0 ms, respectively, in an example of the above-described embodiment, these values are merely exemplary and any other values may be set to those parameters.

In accordance with the present disclosure, the performance can be improved in an ALUA-compliant storage apparatus.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A storage controller that controls a storage apparatus comprising a storage area and a plurality of access paths to the storage area, the storage controller comprising:
an obtaining unit that obtains load information indicating loads of the plurality of access paths;
a determining unit that determines whether or not access paths to the storage area are to be switched, based on the load information;
an identifying unit that identifies a switch candidate access path when it is determined by the determining unit that access paths are to be switched; and
a switch instructing unit that instructs to switch to the switch candidate access path identified by the identifying unit.

2. The storage controller according to claim 1, further comprising a checking unit that checks whether or not the switching of access paths is effective based on the load information after the switching of access paths, and maintains the switching when the switching is effective or reverts the switching of access paths when the switching is not effective.

3. The storage controller according to claim 1, wherein the plurality of access paths have different access priority to the storage area, and
the determining unit determines, based on the load information, that the access paths to the storage area are to be switched when a load of an access path having a higher priority among the plurality of access paths is equal to or higher than a predetermined value, and a load of an access path having a lower priority among the plurality of access paths is smaller than the predetermined value.

4. The storage controller according to claim 1, wherein the identifying unit identifies, as the switch candidate access path, an access path having a lowest load among the plurality of access paths, based on the load information obtained by the obtaining unit.

5. The storage controller according to claim 1, wherein the storage apparatus comprises a plurality of storage areas,
the storage controller controls a part of the plurality of storage areas, and
the obtaining unit obtains the load information for each storage area controlled by the storage controller.

6. The storage controller according to claim 5, wherein the obtaining unit obtains the load information for the storage controller and for each of the storage areas.

7. The storage controller according to claim 6, wherein the identifying unit, identifies, as the switch candidate access path, an access path having a lower priority via a second storage controller different from the storage controller, among access paths via a storage area having the highest load among the storage areas controlled by the storage controller, based on the load information obtained by the obtaining unit.

8. The storage controller according to claim 7, further comprising a path restoring unit that resets all access paths in the storage apparatus when the load on the storage controller is reduced or the load on the second storage controller is increased.

9. A storage apparatus comprising:
a storage area and a plurality of access paths to the storage area;
a storage controller that controls the storage apparatus, the storage controller comprising:
an obtaining unit that obtains load information indicating loads of the plurality of access paths;
a determining unit that determines whether or not access paths to the storage area are to be switched, based on the load information;
an identifying unit that identifies a switch candidate access path when it is determined by the determining unit that access paths are to be switched; and
a switch instructing unit that instructs to switch to the switch candidate access path identified by the identifying unit.

10. The storage apparatus according to claim 9, wherein the storage controller further comprises a checking unit that checks whether or not the switching of access paths is effective based on the load information after the switching of access paths, and maintains the switching when the switching is effective or reverts the switching of access paths when the switching is not effective.

11. The storage apparatus according to claim 9, wherein the plurality of access paths have different access priority to the storage area, and
the determining unit determines, based on the load information, that the access paths to the storage area are to be switched when a load of an access path having a higher priority among the plurality of access paths is equal to or higher than a predetermined value, and a load of an access path having a lower priority among the plurality of access paths is smaller than the predetermined value.

12. The storage apparatus according to claim 9, wherein the identifying unit identifies, as the switch candidate access path, an access path having a lowest load among the plurality of access paths, based on the load information obtained by the obtaining unit.

13. The storage apparatus according to claim 9, wherein the storage apparatus comprises a plurality of storage areas,
the storage controller controls a part of the plurality of storage areas, and
the obtaining unit obtains the load information for each storage area controlled by the storage controller.

14. The storage apparatus according to claim 13, wherein the obtaining unit obtains the load information for the storage controller and for each of the storage areas

15. The storage apparatus according to claim 14, wherein the identifying unit, identifies, as the switch candidate access path, an access path having a lower priority via a second storage controller different from the storage controller, among access paths via a storage area having the highest load among the storage areas controlled by the storage controller, based on the load information obtained by the obtaining unit.

16. The storage apparatus according to claim 15, wherein the storage controller further comprises a path restoring unit that resets all access paths in the storage apparatus when the load on the storage controller is reduced or the load on the second storage controller is increased

17. A non-transitory computer readable storage medium having a storage control program that controls a storage apparatus comprising a storage area and a plurality of access paths to the storage area, stored therein, the storage control program, when executed by a computer, causing the computer to:
obtain load information indicating loads of the plurality of access paths;
determine whether or not access paths to the storage area are to be switched, based on the load information;
identify a switch candidate access path when it is determined that access paths are to be switched; and
instruct to switch to the identified switch candidate access path.

18. The non-transitory computer readable storage medium according to claim 17, wherein the storage control program causes the computer to check whether or not the switching of access paths is effective based on the load information after the switching of access paths, and maintain the switching when the switching is effective or reverts the switching of access paths when the switching is not effective.

19. The non-transitory computer readable storage medium according to claim 17, wherein the plurality of access paths have different access priority to the storage area, and
the storage control program causes the computer to determine, based on the load information, that the access paths to the storage area are to be switched when a load of an access path having a higher priority among the plurality of access paths is equal to or higher than a predetermined value, and a load of an access path having a lower priority among the plurality of access paths is smaller than the predetermined value.

20. The non-transitory computer readable storage medium according to claim 17, wherein the storage control program causes the computer to identify, as the switch candidate access path, an access path having a lowest load among the plurality of access paths, based on the obtained load information.
